(19) United States
(12) Patent Application Publication
(10) Pub. No.: US 2006/0029216 A1
(43) Pub. Date: Feb. 9, 2006

(54) Apparatus and method for communications

(76) Inventor: John Burns, Essex, MA (US)

Correspondence Address: James W. Wiegand, Suite 700, 60 State Street, Boston, MA, 02109, US

(21) Appl. No.: 10/912,604

(22) Filed: Aug. 5, 2004

(51) Int. Cl. H04M 1/00; H04M 9/00

(52) U.S. Cl. 379/430

(57) ABSTRACT

A personal communications device is integrated with a hat. The hat provides support for the communications device and may also protect a user against the elements (e.g., rain, sun, snow). The hat may be made of any of a variety of lightweight, “breathable” materials, such as cloth, straw, or nylon mesh, for example. The hat may also be of any style (men's or women's), including, but not limited to; billed caps, such as baseball caps; brimmed caps, such as a fedora; and brimless hats, such as stocking or watch caps. The communications device may take the form of a two-way radio or a cellular telephone, for example.

### CROSS-REFERENCE TO RELATED APPLICATIONS

None

### FIELD OF THE INVENTION

The invention relates to communications and, in particular, to a convenient housing and support for personal communications devices.

### BACKGROUND OF THE INVENTION

Personal communications devices find many applications and take many forms. Two-way radios are employed by coaches on the sidelines of a football game, by arborists, and by other workers trying to keep in touch with their compatriots. Cellular telephones are ubiquitous and, in some countries, are the default means of communications, taking precedence over landline telephones. The portable nature of such devices (that is, two way radios, cellular telephones, and personal music players) encourages users to multi-task with them; a pedestrian or driver may engage in a cellular telephone conversation while walking or driving, a coach may engage in a spirited conversation on the sidelines as he races towards a field official, or an arborist may talk to fellow workers on the ground as he trims branches high in a tree.

Attempts have been made to provide hands-free operation for communications devices. Many cellular telephone users employ headsets to speak as they walk along a sidewalk or drive in their cars. Headsets provide no protection from the elements (e.g., the rain and snow) Two-way radios are sometimes attached to hardhats, so that construction workers may communicate with one another while working. Hard hats, however, are extraordinarily cumbersome and uncomfortable, due to both their weight and their lack of breathability. By a lack of breathability, I mean that little or no fresh air can get to a wearer's head to help cool the wearer).

Current alternatives do not, however, provide a communications system that allows hands-free operation, provides protection from the elements, and due to its breathability, is comfortable.

An apparatus and method for the housing and support of personal communications devices that provides protection from the elements, is comfortable to the user, and complements a user's apparel would therefore be highly desirable.

### SUMMARY

In accordance with the principles of the present invention, a personal communications device is incorporated with a hat. The hat provides support for the communications device and may also protect a user against the elements (e.g., rain, sun, snow) while providing a fashionable complement to the user's wardrobe.

The hat may be made of any of a variety of lightweight, “breathable” materials, such as cloth, straw, or nylon mesh, for example. The hat may also be of any style (men's or women's), including, but not limited to; billed caps, such as baseball caps; brimmed caps, such as a fedora; and brimless hats, such as stocking or watch caps. The communications device may take the form of a two-way radio, a cellular telephone, or a personal music player, IPod™ for example. The personal communications device includes the elements of a headset (that is, a transceiver, a microphone, and one or more earphones) and, in a cellular telephone embodiment, may also include a handset for dialing, or a display. The communications device may also respond to oral commands.

In addition to offering protection from the elements and providing a fashionable accessory, an integrated communications hat in accordance with the principles of the present invention may provide advertising space for logos. In particular, a baseball style communications hat in accordance with the principles of the present invention may incorporate a logo, such as a Boston Red Sox™ logo, a New England Patriots™ logo, or, for a different market, a DeKalb™ seed corn logo.

In one aspect of the invention, earphones may be incorporated in the hat in a position proximate to a wearer's ears. The earphones may be housed within pockets in such locations or attached to flaps, sliders, pivots or other mechanisms that allow the earphones to be moved from a retracted position to a position directly over the wearer's ears. All manner of earphones, including every size from buds that are insertable into a wearer's ears to earphones that fully encompass a wearer's ears are contemplated within the scope of the invention.

In a cellular telephone embodiment of a communications hat in accordance with the principles of the present invention, a handset or keypad may be housed in the hat in a location that is convenient for dialing. For example, a handset may be housed in a pocket on the bottom side of a baseball-style hat's brim. Additionally, the hat may include a global positioning system (GPS) locator unit or a personal music player, either in conjunction with a cellular telephone, or as a stand-alone component.

### BRIEF DESCRIPTION OF THE DRAWINGS

The above and further features, aspects, and advantages of the invention will be apparent to those skilled in the art from the following detailed description, taken together with the accompanying drawings in which:

FIG. 1 is a conceptual block diagram of a hat-integrated personal communication system in accordance with the principles of the present invention

FIGS. 2A through 2G illustrate various embodiments of a baseball-style cap implementation of a hat-integrated personal communications system in accordance with the principles of the present invention

FIG. 3 is a back plan view that illustrates a distributed electronics embodiment of a hat-integrated communications system in accordance with the principles of the present invention

FIG. 4 is a side plan view that illustrates a fedora or cowboy type hat embodiment of a hat-integrated personal communications system in accordance with the principles of the present invention; and

FIGS. 5A and 5B illustrate a headset baseball style cap embodiment of a hat-integrated personal communications system in accordance with the principles of the present invention.

### DETAILED DESCRIPTION

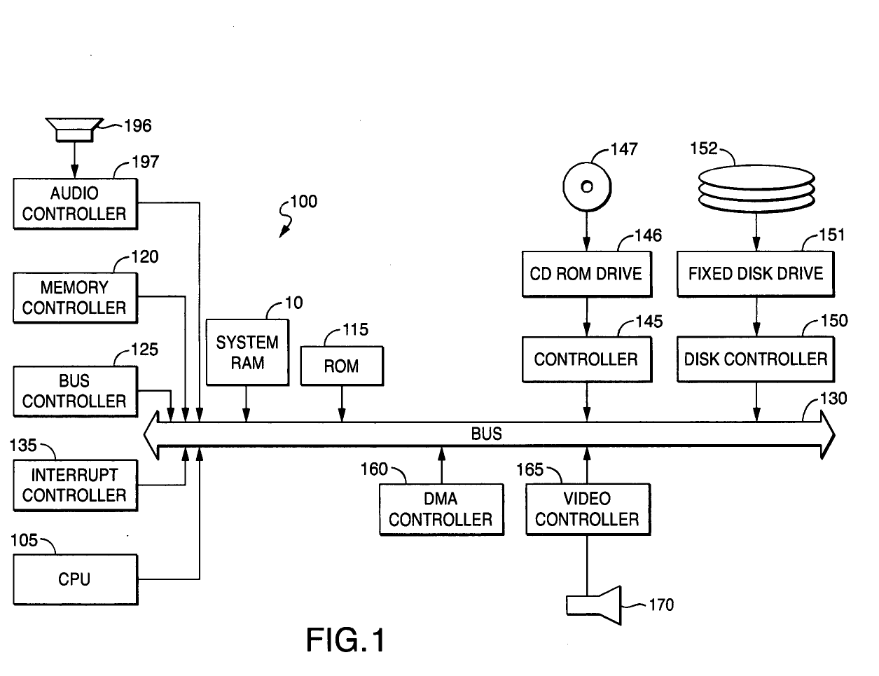

The conceptual block diagram of FIG. 1 illustrates the components of a hat-integrated personal communications device 100 in accordance with the principles of the present invention. A hat 102 supports one or more components of a personal communications device 104 whose components include a microphone 106, one or more earphones 108 and a transceiver 110. In an illustrative embodiment, a global positioning system (GPS) unit 112 is an element of the personal communications device 104. A display 114 and a keypad 116 may also be included, particularly in an embodiment in which the personal communications device 104 is a cellular telephone. The communications device 104 may include a voice-activated system that permits a user to, for example, dial a cellular telephone without using a keypad.

In accordance with the principles of the present invention, the hat 102 provides support for the communications device 104 and may also protect a user against the elements (e.g., rain, sun, snow) while providing a fashionable complement to the user's wardrobe. The hat 102 may be made of any of a variety of lightweight, “breathable” materials, such as cloth, straw, or nylon mesh, for example. The hat 102 may also be of any style (men's or women's), including, but not limited to; billed caps, such as baseball caps; brimmed caps, such as a fedora; and brimless hats, such as stocking or watch caps.

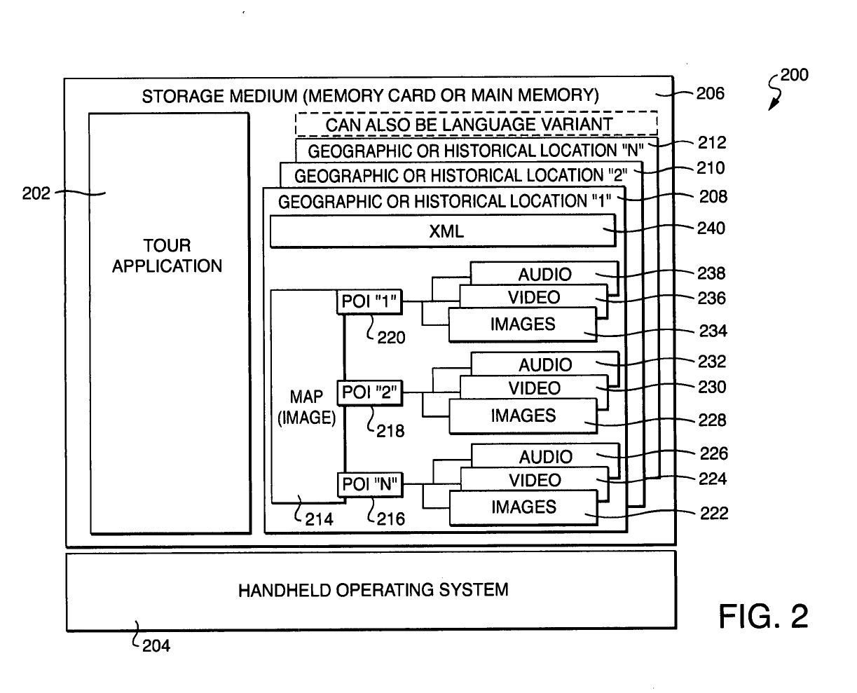

In the illustrative embodiment of FIG. 2A, a baseball-style hat 200 includes a bill 202 that, as described in greater detail in the discussion related to FIG. 2B, may be employed to support a keypad 116, a transceiver 110, or a display 114. Earphones 108 are located on either side of the hat 200 and, as described in greater detail in the discussions related to FIGS. 2B-2G, the earphones may be supported in various ways by the hat 200.

Turning now to the bottom plan view of FIG. 2B, a keypad 116 is mounted on the underside of the bill 202 of the hat 200. The keypad 116 may be permanently mounted in the bill 202, by sowing it into the bill 202, for example. Alternatively, it may be removably mounted to the bill 202, for example, by sliding into a pocket 204 formed into the underside of the bill 202. In this illustrative embodiment, the pocket includes straps 206 configured to hold the keypad securely in place. In this illustrative embodiment, a microphone 106 is incorporated the keypad 116, as, for example, it might be in a cellular telephone embodiment in which a keypad and microphone are often housed in a first component that is connected to another component that houses an earphone and display. A display 114 may be configured, for example, to swing down into a position that permits a user to view the display while wearing the hat 200.

The sectional view of FIG. 2C illustrates in greater detail the mounting and operation of an earphone in an illustrative embodiment of a hat-integrated personal communications system in accordance with the principles of the present invention. An earphone 108 is attached to a flap 208 and held in a reserve position by an attachment means, such as a hook and loop, button, or tab, for example. As indicated by the motion line 212, the flap 208 may be moved into an active position, thereby placing the earphone 108 in closer proximity to a wearer's ear 214.

The sectional view of FIG. 2D illustrates an embodiment of a hat-integrated communications system in accordance with the principles of the present invention in which an earphone 108 may be supported by a slider 216 that allows for movement of the earphone in the direction indicated by the line 218, between retracted and engaged positions (the engaged position being the position in which the earphone is in closest proximity to a wearer's ear canal). The slider 216 may include a bar 217 and strap 219 that operate cooperatively to allow for movement of the bar 217 within the strap 219, thereby allowing the earphone 108 attached to the moveable bar 217 to be retained by the strap and to move along with the bar 217. The bar 217 and strap 219 may include interlocking tabs, or employ friction in order to temporarily fix the earphone 108 in a selected position.

In an embodiment illustrated in the side elevation view of FIG. 2E, a pivot 220 permits an earphone 108 to be pivoted between retracted and engaged positions as indicated by the motion line 222. As illustrated by the front elevation view of FIG. 2F, a hat-integrated communications system in accordance with the principles of the present invention may incorporate signage, such as a stitched logo or an electronic display that allows a wearer to display various messages or logos, for example. In addition to offering protection from the elements and providing a fashionable accessory, an integrated communications hat in accordance with the principles of the present invention may provide advertising space for logos. In particular, a baseball style communications hat in accordance with the principles of the present invention may incorporate a logo, such as a Boston Red Sox™ logo, a New England Patriots™ logo, or, for a different market, a DeKalb™ seed corn logo, for example. The side elevation view of FIG. 2G illustrates an embodiment in which a “bud” type earphone 108 is supported by a wire 226 from the hat 200. As is known in the art, bud type earphones are insertable into a user's ear.

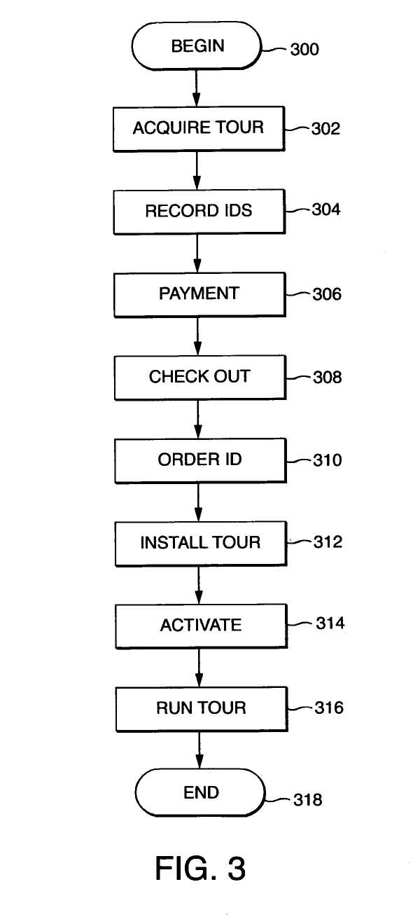

The back elevation view of FIG. 3 illustrates an embodiment of a hat-integrated communications system in which one or more conductors 300, such as wires or flex circuits, are routed through a channel 301 formed in the band of a hat 200. The conductors 300 may connect to one or more components of a personal communications device that is directly supported by the hat 200, such as: earphones 108, a microphone 106, a transceiver 110, a display 114, or a keypad, for example. The conductor(s) may carry electronic signals and/or power to various components of a personal communications device. A junction box 302 accepts a plug 304 for connection to a pack 306 that carries other components of the personal communications system. The pack 306 of the communications device may include such things as a power source (e.g., battery pack or fuel cell), a personal music player, a GPS unit 112 or transceiver 110, for example. By distributing the heavier components of the communications system, into the pack 306, the hat 200 may remain lightweight and comfortable and the heavier components may be carried in a pocket. The junction box 302 and plug 304 are configured for mating and either may have “male” or “female” connection configurations.

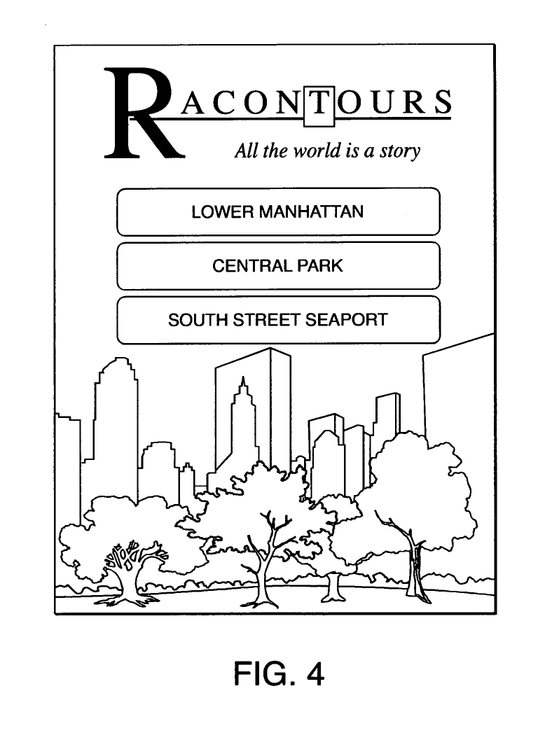

FIG. 4 provides a side elevation view of a fedora style hat that incorporates a personal communications device in accordance with the principles of the present invention. An earphone 108 is shown positioned in close proximity to the location of a wearer's ear. As will be recognized by those of skill in the art, the various components of the communications device may be distributed and configured in comfortable, fashionable, hats, such as the fedora, in a manner as previously described in conjunction with a baseball-style cap.

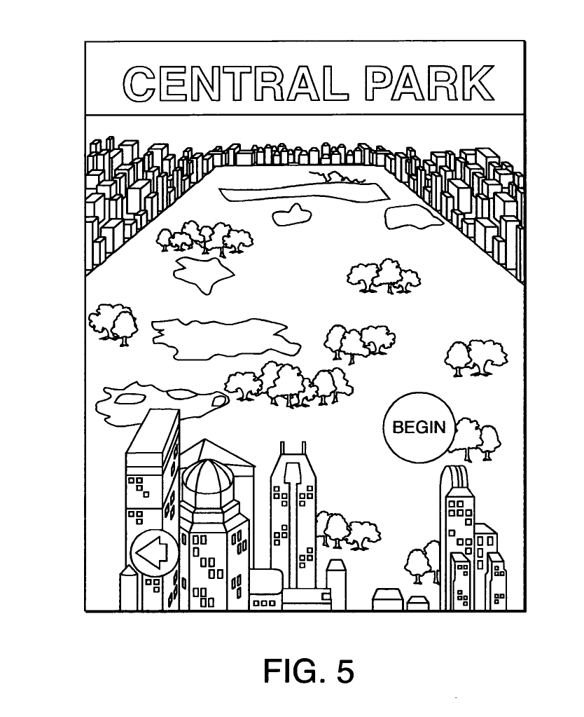

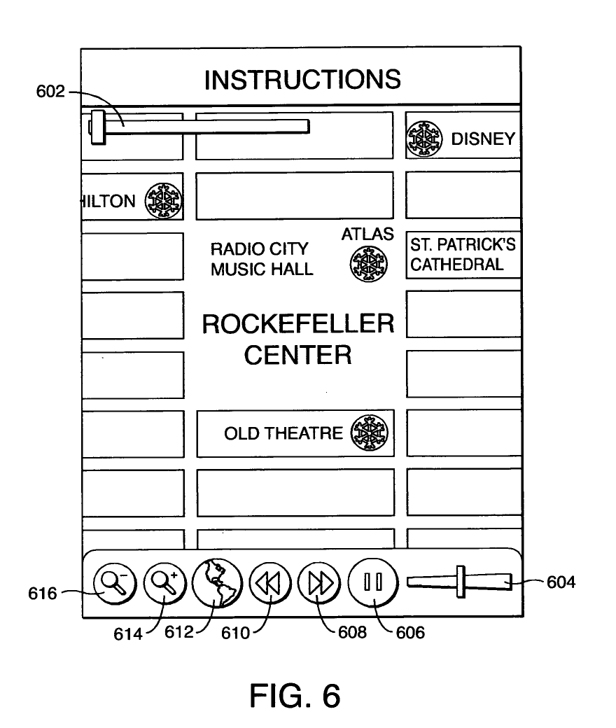

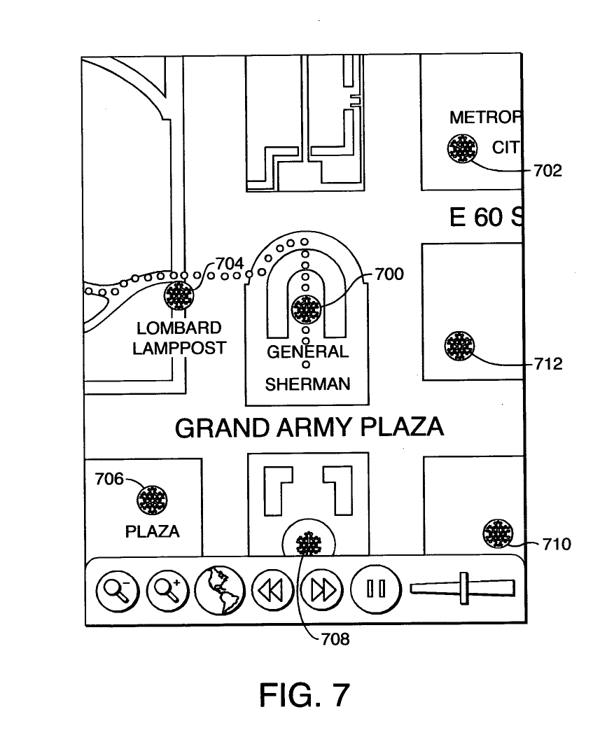

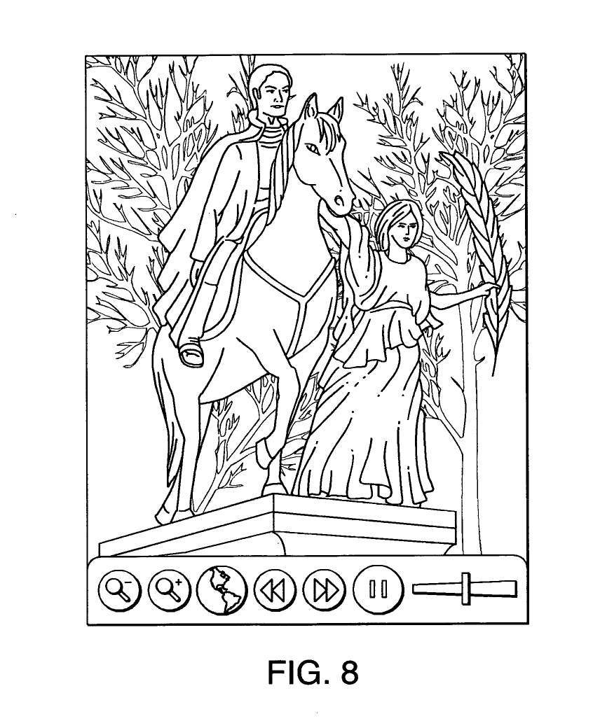

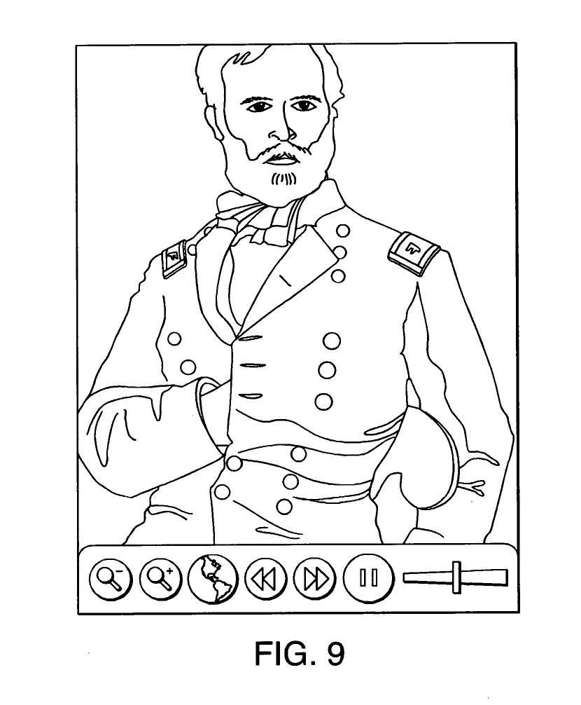

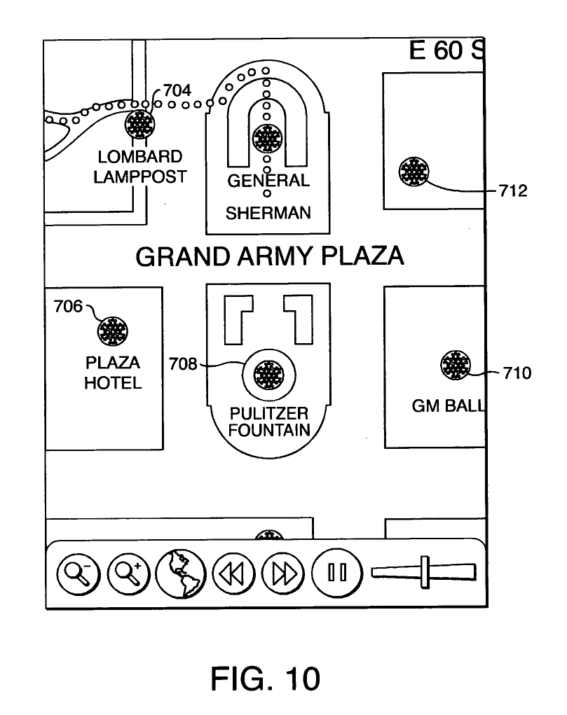

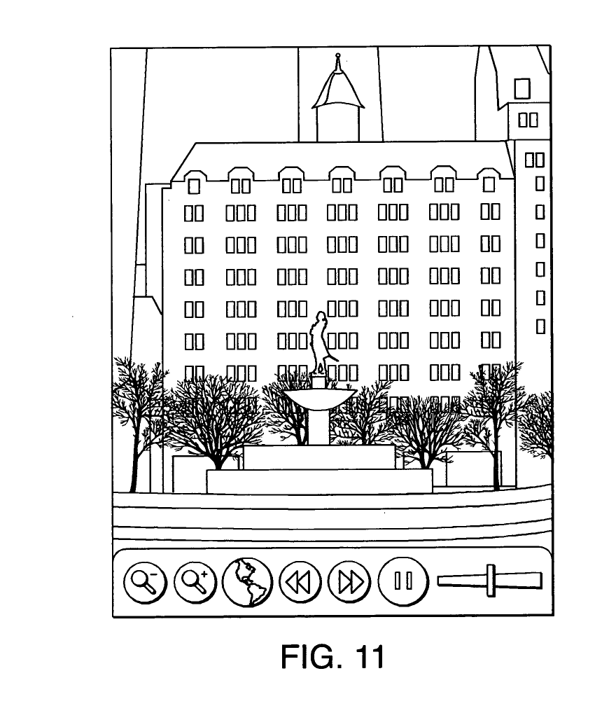

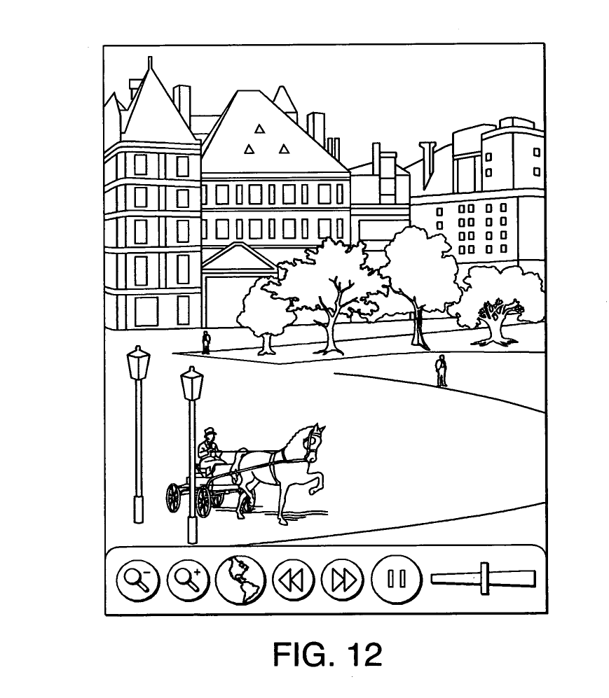

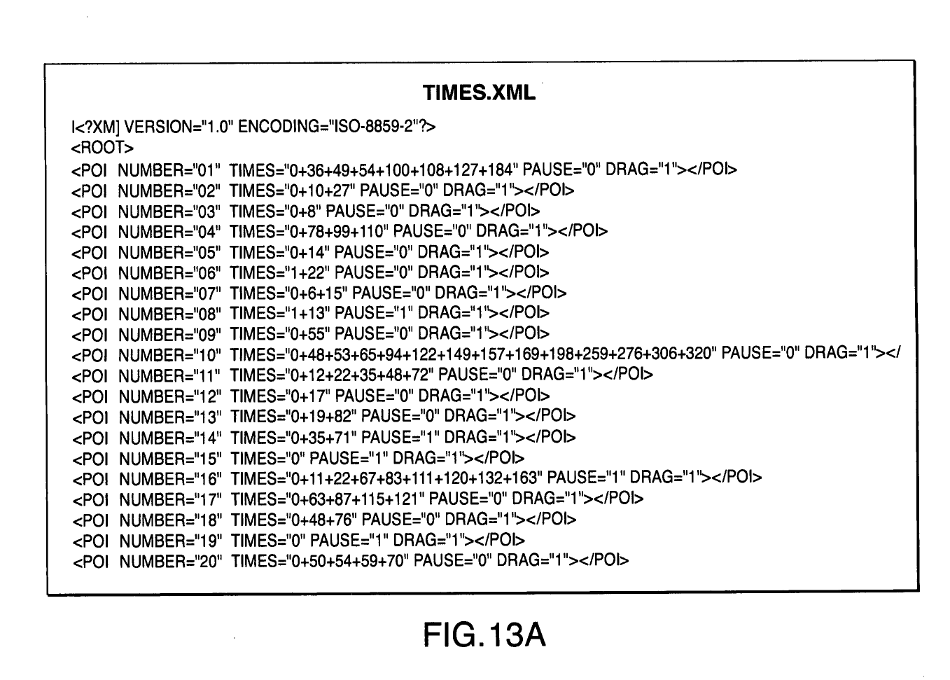

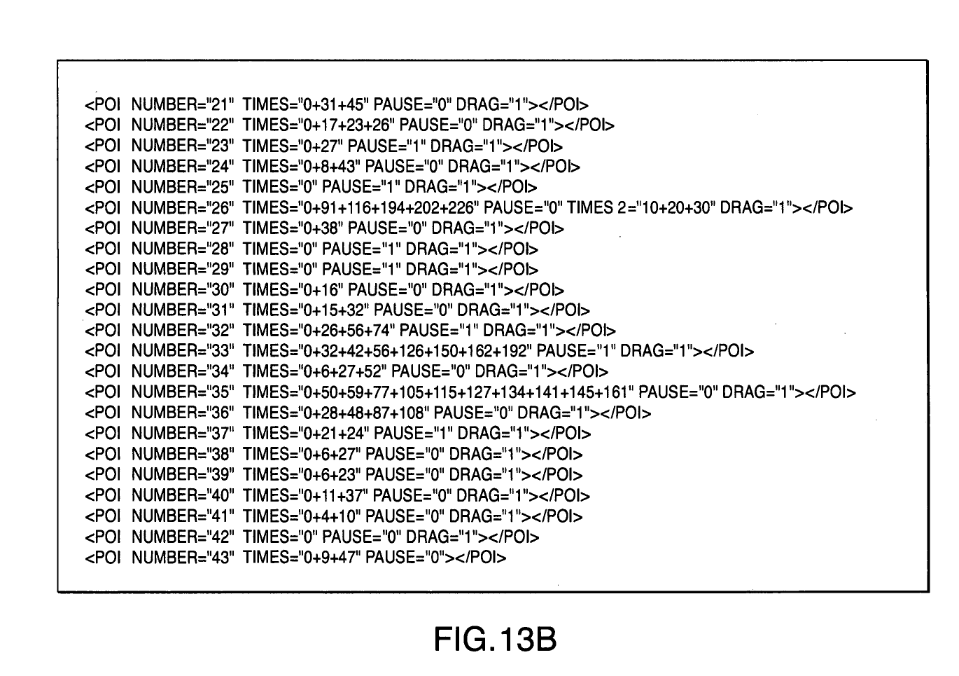

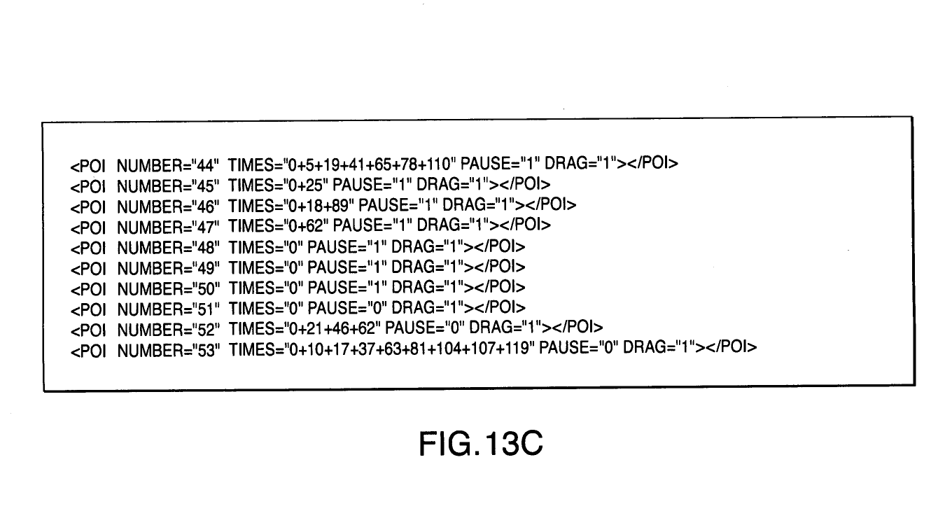

The sectional view of FIG. 5A illustrates an embodiment of a hat-integrated communications system in which a headset 500 which includes a microphone 106 and earphones 108 is housed in a hat 200. In this illustrative embodiment the headset, which may be a lightweight headset such as those often employed with cellular telephones, is held in place within the crown of the hat 200 by attachment means 502. Such headsets are known and described, for example, in U.S. Pat. No. 6,406,811 issued to Hall et al, which is hereby incorporated by reference in its entirety. The attachment means 502 may be a hook and loop, button, or tab device, for example, or may take the form of loops sewn into the inside crown of the hat 200. The sectional view of FIG. 5B provides a side view of the embodiment of FIG. 5A. As indicated by the motion line 504, the position of the microphone 106 may be adjusted for optimal operation and storage.

The foregoing description of specific embodiments of the invention has been presented for the purposes of illustration and description. It is not intended to be exhaustive or to limit the invention to the precise forms disclosed, and many modifications and variations are possible in light of the above teachings. The embodiments were chosen and described to best explain the principles of the invention and its practical application, and to thereby enable others skilled in the art to best utilize the invention. It is intended that the scope of the invention be limited only by the claims appended hereto.

What is claimed is:

1. An apparatus comprising:
a hat; and
a personal communications device incorporated into the hat.

2. The apparatus of claim 1 wherein the hat is a breathable hat.

3. The apparatus of claim 2 wherein the hat is made of woven cloth.

4. The apparatus of claim 1 wherein the hat is a baseball-type cap.

5. The apparatus of claim 1 wherein the hat includes a logo.

6. The apparatus of claim 4 wherein the bill of the hat accommodates a keypad.

7. The apparatus of claim 1 wherein the personal communications device includes earphones situated on either side of the hat proximate a wearer's ears.

8. The apparatus of claim 7 wherein the earphones are retractable.

9. The apparatus of claim 8 wherein the earphones are configured to pivot for retraction.

10. The apparatus of claim 8 wherein the earphones are configured to slide for retraction.

11. The apparatus of claim 8 wherein the earphones are supported by flaps that are configured to be lowered for direct engagement with a wearer's ears.

12. The apparatus of claim 8 wherein the earphones are bud-type earphones deployable from the hat for insertion in a wearer's ears.

13. The apparatus of claim 2 wherein the communications device is a cellular telephone.

14. The apparatus of claim 2 wherein the communications device is a two-way radio.

15. The apparatus of claim 2 wherein the communications device comprises:
a headset;
a microphone; and
a transceiver.

16. The apparatus of claim 15 wherein the hat incorporates the headset, microphone and transceiver directly.

17. The apparatus of claim 15 wherein the hat incorporates the headset and microphone directly and the hat further comprises:
a junction box configured to receive a connection to the transceiver.

18. The apparatus of claim wherein the communications device comprises flexible electronic components.

19. An apparatus comprising:
a hat;
a microphone supported by the hat;
an earphone supported by the hat; and
a transceiver configured to interoperate with the microphone and earphone supported by the hat.

20. The apparatus of claim 19 wherein the transceiver is supported by the hat.

21. The apparatus of claim 19 wherein the transceiver comprises a cellular telephone.

22. The apparatus of claim 21 wherein the transceiver comprises a global positioning system locator.
